(19) United States
(12) Patent Application Publication
(10) Pub. No.: US 2019/0305364 A1
(43) Pub. Date: Oct. 3, 2019

(54) CATHODE MATERIAL FOR LITHIUM ION SECONDARY BATTERY, CATHODE FOR LITHIUM ION SECONDARY BATTERY, AND LITHIUM ION SECONDARY BATTERY

(71) Applicant: SUMITOMO OSAKA CEMENT CO., LTD., Tokyo (JP)

(72) Inventors: Masataka OYAMA, Chiba (JP); Satoru OSHITARI, Chiba (JP); Ryuuta YAMAYA, Chiba (JP); Takao KITAGAWA, Chiba (JP)

(73) Assignee: SUMITOMO OSAKA CEMENT CO., LTD., Tokyo (JP)

(21) Appl. No.: 16/144,271

(22) Filed: Sep. 27, 2018

(30) Foreign Application Priority Data
Mar. 29, 2018 (JP) 2018-064554

(51) Int. Cl. H01M 10/0525; H01M 4/505; H01M 4/525

(52) U.S. Cl. CPC H01M 10/0525; H01M 2004/027; H01M 4/525; H01M 4/505

(57) ABSTRACT

A cathode material for a lithium ion secondary battery enabling diffusion of lithium ions in a two-dimensional direction or a three-dimensional direction in crystals is provided. The cathode material is formed by coating a surface of a central particle represented by-the Formula LixFe1−y−zAyMzPO4 with a carbonaceous film, in which a content of a carbon atom is 0.3% by mass or more and 3.4% by mass or less, and, in a Moessbauer spectrum obtained by Moessbauer spectroscopy, when an area intensity of a spectrum having an isomer shift value in a range of 1.0 mm/sec or more and 1.4 mm/sec or less is represented by α, and an area intensity of a spectrum having an isomer shift value in a range of 0.3 mm/sec or more and 0.7 mm/sec or less is represented by β, {β/((β+α)×(1−y−z)} is 0.01 or more and 0.1 or less.

### TECHNICAL FIELD

The present invention relates to a cathode material for a lithium ion secondary battery, a cathode for a lithium ion secondary battery, and a lithium ion secondary battery.

### BACKGROUND ART

In olivine-based cathode active materials, lithium ions in crystals diffuse only in one-dimensional direction, and thus lithium ion secondary batteries provided with a cathode including an olivine-based cathode active material has a problem in that the diffusion of lithium ions does not catch up with the instantaneous flow of a large electric current and overvoltage (voltage drop) becomes high.

In the related art, it is known that a capacity of a lithium ion secondary battery provided with a cathode including an olivine-based cathode active material can be increased by synthesizing the olivine-based cathode active material made of lithium iron phosphate (LiFePO4) or lithium manganese iron phosphate (LiMn1−xFexPO4) so as to set a content of trivalent Fe to be extremely small (For example, refer to Patent Document 1).

### RELATED ART DOCUMENT

### Patent Document

[Patent Document 1] Japanese Patent No. 4749551

### DISCLOSURE OF THE INVENTION

### Problem that the Invention is to Solve

The present invention has been made in consideration of the above-described circumstance, and an object of the present invention is to provide a cathode material for a lithium ion secondary battery enabling diffusion of lithium ions in a two-dimensional direction or a three-dimensional direction in crystals, a cathode for a lithium ion secondary battery containing the cathode material for a lithium ion secondary battery, and a lithium ion secondary battery including the cathode for a lithium ion secondary battery.

### Means for Solving the Problem

As a result of intensive studies for solving the above-described problem, the present inventors found that, in a cathode material for a lithium ion secondary battery formed by coating a surface of a central particle represented by General Formula LixFe1−y−zAyMzPO4 (here, A represents at least one selected from the group consisting of Mn, Co, and Ni, M represents at least one selected from the group consisting of Mg, Ca, Co, Sr, Ba, Ti, Zn, B, Al, Ga, In, Si, Ge, and rare earth elements, 0.85≤x≤1.1, 0≤y≤0.85, and 0≤z≤0.2) with a carbonaceous film, when a content of a carbon atom is 0.3% by mass or more and 3.4% by mass or less, and, in a Moessbauer spectrum obtained by Moessbauer spectroscopy, when an area intensity of a spectrum having an isomer shift value in a range of 1.0 mm/sec or more and 1.4 mm/sec or less is represented by α, and an area intensity of a spectrum having an isomer shift value in a range of 0.3 mm/sec or more and 0.7 mm/sec or less is represented by β, {β/(β+α)×(1−y−z)} is set to 0.01 or more and 0.1 or less, it becomes possible to diffuse lithium ions in a two-dimensional direction or a three-dimensional direction in crystals by intentionally forming a solid solution of a small amount of trivalent Fe in the crystals and generating defects in the crystals and completed the present invention.

A cathode material for a lithium ion secondary battery of the present invention is a cathode material for a lithium ion secondary battery formed by coating a surface of a central particle represented by General Formula LixFe1−y−zAyMzPO4 (here, A represents at least one selected from the group consisting of Mn, Co, and Ni, M represents at least one selected from the group consisting of Mg, Ca, Co, Sr, Ba, Ti, Zn, B, Al, Ga, In, Si, Ge, and rare earth elements, 0.85≤x≤1.1, 0≤y≤0.85, and 0≤z≤0.2) with a carbonaceous film, in which a content of a carbon atom is 0.3% by mass or more and 3.4% by mass or less, and, in a Moessbauer spectrum obtained by Moessbauer spectroscopy, when an area intensity of a spectrum having an isomer shift value in a range of 1.0 mm/sec or more and 1.4 mm/sec or less is represented by α, and an area intensity of a spectrum having an isomer shift value in a range of 0.3 mm/sec or more and 0.7 mm/sec or less is represented by β, {β/(β+α)×(1−y−z)} is 0.01 or more and 0.1 or less.

An electrode for a lithium ion secondary battery of the present invention is a cathode for a lithium ion secondary battery including an electrode current collector and a cathode mixture layer formed on the electrode current collector, in which the cathode mixture layer contains the cathode material for a lithium ion secondary battery of the present invention.

A lithium ion secondary battery of the present invention is a lithium ion secondary battery having a cathode, an anode, and a non-aqueous electrolyte, in which the cathode for a lithium ion secondary battery of the present invention is provided as the cathode.

### Advantage of the Invention

According to the cathode material for a lithium ion secondary battery of the present invention, it becomes possible to diffuse lithium ions in a two-dimensional direction or a three-dimensional direction in crystals.

According to the cathode for a lithium ion secondary battery of the present invention, the cathode material for a lithium ion secondary battery of the present invention is contained, and thus it is possible to provide a cathode for a lithium ion secondary battery having a low overvoltage.

According to the lithium ion secondary battery of the present invention, the cathode for a lithium ion secondary battery of the present invention is provided, and thus it is possible to provide a lithium ion secondary battery having a low overvoltage.

### BRIEF DESCRIPTION OF THE DRAWING

FIG. 1 is a view illustrating a state in which a spectrum is split into two parts in a Moessbauer spectrum.

### BEST MODE FOR CARRYING OUT THE INVENTION

An embodiment of a cathode material for a lithium ion secondary battery, a cathode for a lithium ion secondary battery, and a lithium ion secondary battery of the present invention will be described.

Meanwhile, the present embodiment is specific description for the better understanding of a gist of the invention and, unless particularly otherwise described, does not limit the present invention.

[Cathode Material for Lithium Ion Secondary Battery]

A cathode material for a lithium ion secondary battery of the present embodiment is a cathode material for a lithium ion secondary battery formed by coating a surface of a central particle represented by General Formula LixFe1−y−zAyMzPO4 (here, A represents at least one selected from the group consisting of Mn, Co, and Ni, M represents at least one selected from the group consisting of Mg, Ca, Co, Sr, Ba, Ti, Zn, B, Al, Ga, In, Si, Ge, and rare earth elements, 0.85≤x≤1.1, 0≤y≤0.85, and 0≤z≤0.2) with a carbonaceous film, in which a content of a carbon atom is 0.3% by mass or more and 3.4% by mass or less, and, in a Moessbauer spectrum obtained by Moessbauer spectroscopy, when an area intensity of a spectrum having an isomer shift value in a range of 1.0 mm/sec or more and 1.4 mm/sec or less is represented by α, and an area intensity of a spectrum having an isomer shift value in a range of 0.3 mm/sec or more and 0.7 mm/sec or less is represented by β, {β/(β+α)×(1−y−z)} is 0.01 or more and 0.1 or less.

The cathode material for a lithium ion secondary battery of the present embodiment is formed by coating the surface of the primary particle of a central particle (cathode active material) made of LixFe1−y−zAyMzPO4 with a carbonaceous film.

An average primary particle diameter of the primary particles of the central particles made of LixFe1−y−zAyMzPO4 is preferably 10 nm or more and 800 nm or less and more preferably 20 nm or more and 500 nm or less.

Here, the reasons for setting the average primary particle diameter of the LixFe1−y−zAyMzPO4 particles to the above-described range are as described below. When the average primary particle diameter of the LixFe1−y−zAyMzPO4 particles is less than 10 nm, the particles become too fine, and it becomes difficult to favorably maintain crystallinity. On the other hand, when the average primary particle diameter of the LixFe1−y−zAyMzPO4 particles exceeds 800 nm, the diffusion distance of lithium ions in the primary particles becomes long, and input and output characteristics deteriorate, which is not preferable.

In the cathode material for a lithium ion secondary battery of the present embodiment, the content of a carbon atom is 0.3% by mass or more and 3.4% by mass or less, preferably 0.5% by mass or more and 3.0% by mass or less, and more preferably 0.6% by mass or more and 2.8% by mass or less.

Here, the reasons for setting the content of the carbon atom in the cathode material for a lithium ion secondary battery of the present embodiment to the above-described range are as described below. When the content of the carbon atom is less than 0.3% by mass, the carbonaceous film on the surface of the primary particle becomes insufficient, and thus the intercalation and deintercalation frequency of lithium ions on the surface of the primary particle decreases, and the input and output characteristics deteriorate, which is not preferable. On the other hand, when the content of the carbon atom exceeds 3.4% by mass, the carbonaceous film on the surface of the primary particle becomes excessive, and thus the carbonaceous film impairs lithium ion conduction, and the input and output characteristics deteriorate, which is not preferable.

In the cathode material for a lithium ion secondary battery of the present embodiment, a method for measuring the content of the carbon atom is as described below.

The content of the carbon atom is measured using a carbon/sulfur analyzer (trade name: EMIA-220V, manufactured by Horiba Ltd.).

In the cathode material for a lithium ion secondary battery of the present embodiment, in a Moessbauer spectrum obtained by a Moessbauer spectroscopic analysis through Moessbauer spectroscopy, when an area intensity of a spectrum having an isomer shift value in a range of 1.0 mm/sec or more and 1.4 mm/sec or less is represented by α, and an area intensity of a spectrum having an isomer shift value in a range of 0.3 mm/sec or more and 0.7 mm/sec or less is represented by β, {β/(β+α)×(1−y−z)} is 0.01 or more and 0.1 or less, {β/(β+α)×(1−y−z)} is preferably 0.02 or more and 0.07 or less, and {β/(β+α)×(1−y−z)} is more preferably 0.03 or more and 0.06 or less.

When {β/(β+)×(1−y−z)} is in the above-described range, it becomes possible to diffuse lithium ions in a two-dimensional direction or a three-dimensional direction in crystals by forming a solid solution of a small amount of trivalent Fe in the crystals of the central particle made of LixFe1−y−zAyMzPO4 and generating defects in the crystals.

In addition, when {/(β+α)×(1−y−z)} is less than 0.01, the amount of defects in the crystals becomes insufficient, and a diffusion rate of lithium ions in the crystals becomes slow, which is not preferable. On the other hand, when {β/(β+α)×(1−y−z)} exceeds 0.1, a ratio of electrochemically unstable Fe becomes excessive, and a battery capacity of the cathode material per unit mass decreases, which is not preferable.

The Moessbauer spectroscopic analysis is carried out by investigating, when a γ ray discharged from a Moessbauer nucleus (57Fe in the excitation basis in a disintegration process of 57Co→57Fe) incorporated as a radioactive isotope (radiation source) in a solid is not recoiled, but resonantly absorbed by the same kind of Moessbauer nucleus in the ground state in another solid (specimen), the energy dependency of the absorption amount of the γ ray or the scattering amount of the γ ray discharged after absorption (Moessbauer spectrum).

In the present embodiment, on the basis of an assumption that a spectrum obtained by the Moessbauer spectroscopic analysis can be approximated using a Lorentz-type theoretical linear expression, the peak full widths at half maximum of individual components are all equal to one another, peak heights in symmetric locations are equal to one another, and the spectrum is a theoretical linear addition, curve fitting is carried out, peak locations are specified, and the area intensities of the individual components are obtained. As the theoretical linear expression, an expression represented by Expression (1) is used.

$$f ( E ) = B - {\sum }_{i = 1}^{n} \frac{{I}_{i} {Γ}_{i}^{2} / 4}{{( {E}_{i} - {x}_{oi} ( δ , Δ , H ) )}^{2} + {Γ}_{i}^{2} / 4} \qquad ( 1 )$$

In Expression (1), f(E) represents a counter at a Doppler rate E, E represents the Doppler rate (linearly proportional to energy), B represents a counter of a base line, Iᵢ represents an absorption intensity of an i^{th} peak, Γᵢ represents a full width at half maximum of the i^{th} peak, x₀ᵢ represents a peak center of the i^{th} peak, δ represents an isomer shift, Δ represents a quadrupolar split, and H represents an internal magnetic field.

In addition, the relative area ratios of the individual components when the square sum of the residual error is minimized in the least-square method is considered as the area intensity of the spectrum.

In the present embodiment, in the spectrum obtained by the Moessbauer spectroscopy, in a case in which Fe is paramagnetic (internal magnetic field H═O), two split peaks are obtained, in a case in which Fe is ferromagnetic or antiferromagnetic (internal magnetic field H≠0), six split peaks are obtained, and the number of peaks observed is only two or six.

In the cathode material for a lithium ion secondary battery of the present embodiment, in the Moessbauer spectrum obtained by the Moessbauer spectroscopy, a spectrum having an isomer shift value in a range of 1.0 mm/sec or more and 1.4 mm/sec or less and a spectrum having an isomer shift value in a range of 0.3 mm/sec or more and 0.7 mm/sec or less are preferably split into two parts respectively.

The spectrum in which the above-described two spectra are split into two parts respectively is attributed to paramagnetic Fe, and thus Fe attributed to the spectrum having the isomer shift value in a range of 1.0 mm/sec or more and 1.4 mm/sec or less is capable of carrying out charge compensation accompanied by the intercalation and deintercalation of lithium ions, and Fe attributed to the spectrum having the isomer shift value in a range of 0.3 mm/sec or more and 0.7 mm/sec or less creates defects in crystals and enables the two-dimensional diffusion or three-dimensional diffusion of lithium ions in the crystals, which is preferable.

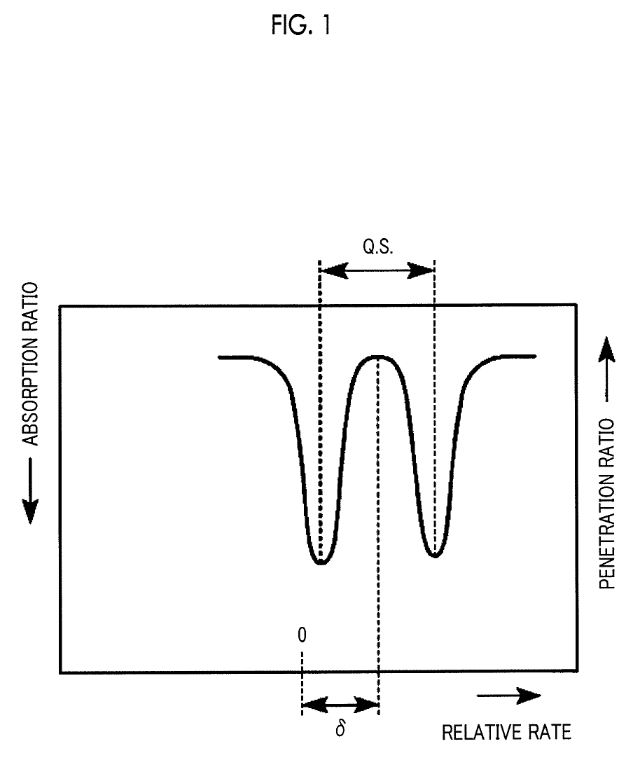

Meanwhile, the spectrum being split into two parts in the Moessbauer spectrum refers to a state as illustrated in FIG. 1.

In the cathode material for a lithium ion secondary battery of the present embodiment, in the Moessbauer spectrum obtained by the Moessbauer spectroscopy, the quadrupolar split value of the spectrum having an isomer shift value in a range of 0.3 mm/sec or more and 0.7 mm/sec or less is preferably 0.4 mm/sec or more and 1.1 mm/sec or less and more preferably 0.5 mm/sec or more and 1.1 mm/sec or less.

When the quadrupolar split value of the spectrum is 0.4 mm/sec or more, the isotropy around Fe is poor, and defects are present in the crystals to an appropriate extent, and thus the input and output characteristics can be improved, which is preferable. Meanwhile, when the quadrupolar split value of the spectrum is 1.1 mm/sec or less, the isotropy around Fe is favorable, the crystal structure is stabilized, and the strain of the crystal structure accompanied by charging and discharging can be suppressed, which is preferable.

Meanwhile, the quadrupolar split value in the Moessbauer spectrum refers to the peak interval between the two split parts of the spectrum. Generally, the spectrum is considered to be split into two parts in a case in which ligands have different electronegativity even when coordinated in a structurally isotropic manner, a case in which the disposition is structurally distorted, and a case in which the above-described two cases are mixed together.

The cathode material for a lithium ion secondary battery of the present embodiment preferably does not include six magnetically split peaks in the Moessbauer spectrum obtained by the Moessbauer spectroscopy.

In the Moessbauer spectrum, when six magnetically split peaks that are attributed to ferromagnetic or antiferromagnetic Fe are not included, it is possible to decrease the amount of an electrochemically unstable ferromagnetic or antiferromagnetic Fe compound, and the battery capacity of the cathode material per unit mass can be improved, which is preferable.

A thickness of the carbonaceous film is preferably 1 nm or more and 5 nm or less.

The reasons for setting the thickness of the carbonaceous film to the above-described range are as described below. When the thickness of the carbonaceous film is less than 1 nm, the thickness of the carbonaceous film is too thin, and thus it becomes impossible to form a film having a desired resistance value. As a result, the conductivity decreases, and it becomes impossible to ensure conductivity suitable to a cathode material. Meanwhile, when the thickness of the carbonaceous film exceeds 5 nm, a battery activity, for example, the battery capacity of the cathode material per unit mass decreases.

A coating ratio of the carbonaceous film is preferably 80% or more and more preferably 60% or more and 95% by mass or less. When the coating ratio of the carbonaceous film is 60% or more, a coating effect of the carbonaceous film can be sufficiently obtained.

An average primary particle diameter of primary particles made of LixFe1−y−zAyMzPO4 which are coated with the carbonaceous film is preferably 10 nm or more and 800 nm or less and more preferably 20 nm or more and 500 nm or less.

Here, the reasons for setting the average primary particle diameter of the primary particles made of LixFe1−y−zAyMzPO4 which are coated with the carbonaceous film (hereinafter, referred to as the “carbonaceous electrode active material composite particles”) to the above-described range are as described below. When the average primary particle diameter is less than 10 nm, a specific surface area of the carbonaceous electrode active material composite particles increases, and thus a mass of carbon that becomes necessary increases, and a charge and discharge capacity decreases. Furthermore, carbon coating becomes difficult, a primary particle having a sufficient coating ratio cannot be obtained, and, particularly, a favorable mass energy density at a low temperature or in high-speed charge and discharge cannot be obtained. Meanwhile, when the average primary particle diameter exceeds 500 nm, the migration of lithium ions or the migration of electrons in the carbonaceous electrode active material composite particles takes time, and thus an internal resistance increases, and output characteristics deteriorate, which is not preferable.

A shape of the primary particle made of LixFe1−y−zAyMzPO4 which is coated with the carbonaceous film is not particularly limited, but a cathode material made of a spherical, particularly, truly spherical particle is easily generated, and thus the shape of the primary particle is also preferably a spherical shape.

Here, the reasons for the shape being preferably a spherical shape are as described below. An amount of a solvent used to prepare a cathode material paste for a lithium ion secondary battery by mixing the primary particle coated with the carbonaceous film, a binder, and a solvent can be decreased. Furthermore, the application of this cathode material paste for a lithium ion secondary battery to an electrode current collector also becomes easy. In addition, when the shape is a spherical shape, the surface area of the primary particle is minimized, furthermore, a mixing amount of the binder being added can be minimized, and the internal resistance of a cathode to be obtained can be decreased.

Furthermore, when the shape of the primary particle is set to be a spherical shape, particularly, a truly spherical shape, it becomes easy to closely pack the primary particle. Therefore, an amount of the cathode material for a lithium ion secondary battery packed per unit volume increases, consequently, an electrode density can be increased, and it is possible to increase the capacity of a lithium ion secondary battery, which is preferable.

In addition, a ratio ([carbon supporting amount]/[specific surface area]) of a carbon supporting amount to a specific surface area of the cathode material for a lithium ion secondary battery is preferably 0.4 mg/m² or more and 2.0 mg/m² or less and more preferably 0.5 mg/m² or more and 1.6 mg/m² or less.

Here, the reasons for setting the ratio of the carbon supporting amount to the specific surface area of the cathode material for a lithium ion secondary battery of the present embodiment to the above-described range are as described below. When the ratio of the carbon supporting amount to the specific surface area is less than 0.4 mg/m², a discharge capacity at a high charge-discharge rate becomes low in the case of forming a lithium ion secondary battery, and it becomes difficult to realize sufficient charge and discharge rate performance. Meanwhile, when the ratio of the carbon supporting amount to the specific surface area exceeds 2.0 mg/m², an amount of carbon is too great, and a battery capacity of the lithium ion secondary battery per unit mass of the primary particle decreases more than necessary.

A specific surface area of the cathode material for a lithium ion secondary battery of the present embodiment is preferably 1 m²/g or more and 100 m²/g or less, more preferably 3 m²/g or more and 50 m²/g or less, and still more preferably 6 m²/g or more and 30 m²/g or less.

Here, the reasons for setting the specific surface area of the cathode material for a lithium ion secondary battery of the present embodiment to the above-described range are as described below. When the specific surface area is less than 1 m²/g, the migration of lithium ions or the migration of electrons in the carbonaceous electrode active material composite particles takes time, and thus an internal resistance increases, and output characteristics deteriorate, which is not preferable. When the specific surface area exceeds 100 m²/g, a specific surface area of the carbonaceous electrode active material composite particles increases, whereby the mass of carbon that becomes necessary increases, and the charge and discharge capacity decreases. Furthermore, carbon coating becomes difficult, a primary particle having a sufficient coating ratio cannot be obtained, and, particularly, a favorable mass energy density at a low temperature or in high-speed charge and discharge cannot be obtained, which is not preferable.

“Central Particle”

The central particle is made of LixFe1−y−zAyMzPO4 (here, Δ represents at least one selected from the group consisting of Mn, Co, and Ni, M represents at least one selected from the group consisting of Mg, Ca, Co, Sr, Ba, Ti, Zn, B, Al, Ga, In, Si, Ge, and rare earth elements, 0.85≤x≤1.1, 0≤y≤0.85, and 0≤z≤0.2) having a crystal structure preferable for the diffusion of Li.

In LixFe1−y−zAyMzPO4, the reasons for setting x to satisfy 0.85≤x≤1.1 are as described below. When x is less than 0.85, in the case of using an active material not including lithium ions for an anode, an amount of lithium ions in a battery decreases, and the battery capacity decreases, which is not preferable. Meanwhile, when x exceeds 1.1, an olivine structure cannot be maintained, and crystal stability degrades, which is not preferable.

In LixFe1−y−zAyMzPO4, the reasons for setting y to satisfy 0≤y≤0.85 are as described below. When y exceeds 0.85, a ratio of Fe becomes too small, a lithium ion diffusion rate or an electron conduction rate in the crystals decreases, and the input and output characteristics degrade, which is not preferable.

In LixFe1−y−zAyMzPO4, the reasons for setting z to satisfy 0≤z≤0.2 are as described below. When z exceeds 0.2, a ratio of electrochemically inactive metal increases, and thus the battery capacity per unit mass of the cathode material decreases, which is not preferable.

LixFe1−y−zAyMzPO4 in the present embodiment preferably satisfies y=0 and z=0. That is, in the cathode material for a lithium ion secondary battery of the present embodiment, the central particle is preferably made of LiFePO4.

When the central particle is made of LiFePO4, the lithium ion diffusion rate or the electron conduction rate in the crystals improves, and the input and output characteristics improve.

An average particle diameter (average secondary particle diameter) of a granulated body formed by agglomerating a plurality of the primary particles is preferably 0.5 μm or more and 20 μm or less, more preferably 0.7 μm or more and 8 μm or less, and still more preferably 0.7 μm or more and 6 μm or less.

When the average particle diameter of the granulated body is 0.5 μm or more, it is possible to suppress an amount of the conductive auxiliary agent and the binder blended to prepare the cathode material paste for a lithium ion secondary battery by mixing the cathode material, the conductive auxiliary agent, a binder resin (binder), and the solvent. Therefore, it is possible to increase the battery capacity of a lithium ion secondary battery per unit mass of the cathode mixture layer for a lithium ion secondary battery. Meanwhile, when the average particle diameter of the granulated body is 20 μm or less, it is possible to enhance the dispersibility and uniformity of the conductive auxiliary agent or the binder in the cathode mixture layer. As a result, a lithium ion secondary battery for which the cathode material for a lithium ion secondary battery of the present embodiment is used is capable of increasing the discharge capacity in high-speed charge and discharge.

“Carbonaceous Film”

The carbonaceous film is a pyrolytic carbonaceous film obtained by carbonizing an organic compound that serves as a raw material. A source of carbon that serves as a raw material of the carbonaceous film is preferably derived from an organic compound having a purity of carbon of 42.00% or more and 60.00% or less.

As a method for calculating “the purity of carbon” of the source of carbon that serves as a raw material of the carbonaceous film in the cathode material for a lithium ion secondary battery of the present embodiment, in a case of a plurality of kinds of organic compounds is used, a method in which amounts (% by mass) of carbon in amounts of the respective organic compounds blended are calculated and summed from the amounts (% by mass) of the respective organic compounds blended and a well-known purity (%) of carbon and the purity of carbon is calculated according to Expression (2) using a total amount (% by mass) of the organic compounds blended and a total amount (% by mass) of carbon is used.

Purity (%) of carbon=total amount (% by mass) of carbon/total amount blended (% by mass)×100 (2)

According to the cathode material for a lithium ion secondary batter of the present embodiment, in a cathode material for a lithium ion secondary battery formed by coating a surface of a central particle represented by General Formula LixFe1−y−zAyMzPO4 (here, Δ represents at least one selected from the group consisting of Mn, Co, and Ni, M represents at least one selected from the group consisting of Mg, Ca, Co, Sr, Ba, Ti, Zn, B, Al, Ga, In, Si, Ge, and rare earth elements, 0.85≤x≤1.1, 0≤y≤0.85, and 0≤z≤0.2) with a carbonaceous film, the content of a carbon atom is 0.3% by mass or more and 3.4% by mass or less, and, in a Moessbauer spectrum obtained by Moessbauer spectroscopy, when the area intensity of a spectrum having an isomer shift value in a range of 1.0 mm/sec or more and 1.4 mm/sec or less is represented by α, and the area intensity of a spectrum having an isomer shift value in a range of 0.3 mm/sec or more and 0.7 mm/sec or less is represented by β, {β/(β+α)×(1−y−z)} is set to 0.01 or more and 0.1 or less, whereby it becomes possible to diffuse lithium ions in a two-dimensional direction or a three-dimensional direction in crystals by intentionally forming a solid solution of a small amount of trivalent Fe in the crystals and generating defects in the crystals. Therefore, a lithium ion secondary battery provided with a cathode for a lithium ion secondary battery including the cathode material for a lithium ion secondary battery of the present embodiment has a low overvoltage.

[Method for Manufacturing Cathode Material for Lithium Ion Secondary Battery]

A method for manufacturing the cathode material for a lithium ion secondary battery of the present embodiment is not particularly limited; however, for example, a method having a step of synthesizing a LixFe1−y−zAyMzPO4 particle under pressurization by heating a raw material slurry α obtained by mixing a Li source, a Fe source, an A source, an M source, and a P source with a solvent containing water as a main component to a temperature in a range of 100° C. or higher and 300° C. or lower and a step of coating the surface of the LixFe1−y−zAyMzPO4 particle (primary particle) with a carbonaceous film by drying and granulating a raw material slurry β formed by dispersing the LixFe1−y−zAyMzPO4 particle in a water solvent including a carbon source and then heating the granulated body to a temperature in a range of 500° C. or higher and 1,000° C. or lower is exemplified.

A method for adjusting {(β/(β+α)×(1−y−z)} of the cathode material for a lithium ion secondary battery of the present embodiment to fall in a range of 0.01 or more and 0.1 or less is not particularly limited; however, for example, a method in which a solid solution of trivalent Fe is formed in crystals using both a divalent Fe compound and a trivalent Fe compound as a Fe source during hydrothermal synthesis. In this case, when the amounts of the divalent Fe compound and the trivalent Fe compound used are adjusted, it is possible to adjust the area intensity α of a spectrum having an isomer shift value attributed to the divalent Fe in a range of 1.0 mm/sec or more and 1.4 mm/sec or less and the area intensity β of a spectrum having an isomer shift value attributed to the trivalent Fe in a range of 0.3 mm/sec or more and 0.7 mm/sec or less and adjust {β/(β+α)×(1−y−z)} to fall in a range of 0.01 or more and 0.1 or less.

A method for synthesizing the LixFe1−y−zAyMzPO4 particle is not particularly limited; however, for example, a Li source, a Fe source, an A (at least one selected from the group consisting of Mn, Co, and Ni) source, an M (at least one selected from the group consisting of Mg, Ca, Co, Sr, Ba, Ti, Zn, B, Al, Ga, In, Si, Ge, and a rare earth element) source, and a P source are injected into a solvent containing water as a main component and stirred, thereby preparing the raw material slurry α including a precursor of LixFe1−y−zAyMzPO4.

The Li source, the Fe source, the A source, the M source, and the P source are injected into the solvent containing water as a main component so as to a molar ratio thereof (Li source:Fe source:A source:M source:P source), that is, a molar ratio of Li:Fe:A:M:P reaches 0.85 to 5:0.1 to 2:0 to 2:0 to 2:1 to 2 and stirred and mixed together, thereby preparing the raw material slurry α.

When the uniform mixing of the Li source, the Fe source, the A source, the M source, and the P source is taken into account, it is preferable to, first, form solid solution states of the Li source, the Fe source, the A source, the M source, and the P source respectively and mix the solid solutions.

Molar concentrations of the Li source, the Fe source, the A source, the M source, and the P source in this raw material slurry α are preferably 0.1 mol/L or more and 3 mol/L or less since it is necessary to obtain a LixFe1−y−zAyMzPO4 particle that is highly pure, highly crystalline, and extremely fine.

Examples of the Li source include hydroxides such as lithium hydroxide (LiOH), lithium inorganic acid salts such as lithium carbonate (Li2CO3), lithium chloride (LiCl), lithium nitrate (LiNO3), lithium phosphate (Li3PO4), lithium hydrogen phosphate (Li2HPO4), and lithium dihydrogen phosphate (LiH2PO4), lithium organic acid salts such as lithium acetate (LiCH3COO) and lithium oxalate ((COOLi)2), and hydrates thereof. As the Li source, at least one selected from the above-described group is preferably used.

Meanwhile, lithium phosphate (Li3PO4) can be used as the Li source and the P source.

As the Fe source, for example, as the divalent Fe compound, iron compounds such as iron (II) chloride (FeCl2), iron (II) sulfate (FeSO4), or iron (III) acetate (Fe(CH3COO)2) and hydrates thereof can be used, and, as the trivalent Fe compound, iron compounds such as iron (III) phosphate (FePO4), iron (III) nitrate (Fe(NO3)3), iron (III) chloride (FeCl3), and iron (II) citrate (FeC6H5O7) and hydrates thereof can be used. Only the divalent Fe compound may be used as the Fe source, only the trivalent Fe compound may be used as the Fe source, and both the divalent Fe compound and the trivalent Fe compound may be used as the Fe source. It is preferable to use both the divalent Fe compound and the trivalent Fe compound as the Fe source since it becomes easy to form a solid solution of trivalent Fe in crystals.

As the Mn source, a Mn salt is preferred, and examples thereof include manganese (II) chloride (MnCl2), manganese (II) sulfate (MnSO4), manganese (II) nitrate (Mn(NO3)2), manganese (II) acetate (Mn(CH3COO)2), and hydrates thereof. As the Mn source, at least one selected from the above-described group is preferably used.

As the Co source, a Co salt is preferred, and examples thereof include cobalt (II) chloride (CoCl2), cobalt (II) sulfate (CoSO4), cobalt (II) nitrate (Co(NO3)2), cobalt (II) acetate (Co(CH3COO)2), and hydrates thereof. As the Co source, at least one selected from the above-described group is preferably used.

As the Ni source, a Ni salt is preferred, and examples thereof include nickel (II) chloride (NiCl2), nickel (II) sulfate (NiSO4), nickel (II) nitrate (Ni(NO3)2), nickel (II) acetate (Ni(CH3COO)2), and hydrates thereof. As the Ni source, at least one selected from the above-described group is preferably used.

As the Mg source, a Mg salt is preferred, and examples thereof include magnesium (II) chloride (MgCl2), magnesium (II) sulfate (MgSO4), magnesium (II) nitrate (Mg(NO3)2), magnesium (II) acetate (Mg(CH3COO)2), and hydrates thereof. As the Mg source, at least one selected from the above-described group is preferably used.

As the Ca source, a Ca salt is preferred, examples thereof include calcium (II) chloride (CaCl2)), calcium (II) sulfate (CaSO4), calcium (II) nitrate (Ca(NO3)2), calcium (II) acetate (Ca(CH3COO)2), and hydrates thereof, and at least one selected from the group consisting of the above-described compounds is preferably used.

As the Co source, a Co salt is preferred, and examples thereof include cobalt (II) chloride (CoCl2), cobalt (II) sulfate (CoSO4), cobalt (II) nitrate (Co(NO3)2), cobalt (II) acetate (Co(CH3COO)2), and hydrates thereof. As the Co source, at least one selected from the above-described group is preferably used.

As the Sr source, a Sr salt is preferred, examples thereof include strontium carbonate (SrCo3), strontium sulfate (SrSO4), and strontium hydroxide (Sr(OH)2), and at least one selected from the group consisting of the above-described compounds is preferably used.

As the Ba source, a Ba salt is preferred, examples thereof include barium (II) chloride (BaCl2), barium (II) sulfate (BaSO4), barium (II) nitrate (Ba(NO3)2), barium (II) acetate (Ba(CH3COO)2), and hydrates thereof, and at least one selected from the group consisting of the above-described compounds is preferably used.

As the Ti source, a Ti salt is preferred, examples thereof include titanium chloride (TiCl4, TiCl3, TiCl2), titanium oxide (TiO), and hydrates thereof, and at least one selected from the group consisting of the above-described compounds is preferably used.

As the Zn source, a Zn salt is preferred, and examples thereof include zinc (II) chloride (ZnCl2), zinc (II) sulfate (ZnSO4), zinc (II) nitrate (Zn(NO3)2), zinc (II) acetate (Zn(CH3COO)2), and hydrates thereof. As the Zn source, at least one selected from the group consisting of the above-described compounds is preferably used.

As the B source, boron compounds such as a chloride, a sulfoxide, a nitroxide, an acetoxide, a hydroxide, and an oxide are exemplified, and at least one selected from the group consisting of the above-described compounds is preferably used.

As the Al source, for example, aluminum compounds such as a chloride, a sulfoxide, a nitroxide, an acetoxide, and a hydroxide are exemplified, and at least one selected from the group consisting of the above-described compounds is preferably used.

As the Ga source, for example, gallium compounds such as a chloride, a sulfoxide, a nitroxide, an acetoxide, and a hydroxide are exemplified, and at least one selected from the group consisting of the above-described compounds is preferably used.

As the In source, for example, indium compounds such as a chloride, a sulfoxide, a nitroxide, an acetoxide, and a hydroxide are exemplified, and at least one selected from the group consisting of the above-described compounds is preferably used.

As the Si source, for example, sodium silicate, potassium silicate, silicon tetrachloride (SiCl4), silicate, organic silicon compounds, and the like are exemplified, and at least one selected from the group consisting of the above-described compounds is preferably used.

As the Ge source, for example, germanium compounds such as a chloride, a sulfoxide, a nitroxide, an acetoxide, a hydroxide, and an oxide are exemplified, and at least one selected from the group consisting of the above-described compounds is preferably used.

As the rare earth element source, for example, a chloride, a sulfoxide, a nitroxide, an acetoxide, a hydroxide, and an oxide of Sc, Y, La, Ce, Pr, Nd, Pm, Sm, Eu, Gd, Tb, Dy, Ho, Er, Tm, Yb, and Lu are exemplified, and at least one selected from the group consisting of the above-described compounds is preferred.

As the P source, for example, at least one selected from phosphates such as orthophosphoric acid (H3PO4) and metaphosphoric acid (HPO3), ammonium dihydrogen phosphate (NH4H2PO4), diammonium hydrogen phosphate ((NH4)2HPO4), ammonium phosphate ((NH4)3PO4), lithium phosphate (Li3PO4), dilithium hydrogen phosphate (Li2HPO4), lithium dihydrogen phosphate (LiH2PO4) and hydrate thereof is preferably used.

The solvent containing water as a main component may be any of water alone or a water-based solvent containing water as a main component and including an aqueous solvent such as an alcohol as necessary.

The aqueous solvent is not particularly limited as long as the solvent is capable of dissolving the Li source, the Fe source, the A source, the M source, and the P source. Examples thereof include alcohols such as methanol, ethanol, 1-propanol, 2-propanol (isopropyl alcohol: IPA), butanol, pentanol, hexanol, octanol, and diacetone alcohol, esters such as ethyl acetate, butyl acetate, ethyl lactate, propylene glycol monomethyl ether acetate, propylene glycol monoethyl ether acetate, and γ-butyrolactone, ethers such as diethyl ether, ethylene glycol monomethyl ether (methyl cellosolve), ethylene glycol monoethyl ether (ethyl cellosolve), ethylene glycol monobutyl ether (butyl cellosolve), diethylene glycol monomethyl ether, and diehtylene glycol monoethyl ether, ketones such as acetone, methyl ethyl ketone (MEK), methyl isobutyl ketone (MIBK), acetylacetone, and cyclohexanone, amides such as dimethyl formamide, N,N-dimethylacetoacetamide, and N-methyl-2-pyrrolidinone, glycols such as ethylene glycol, diethylene glycol, and propylene glycol, and the like. These aqueous solvents may be used singly or two or more aqueous solvents may be used in mixture.

Next, this raw material slurry α is put into a pressure resistant vessel, heated to a temperature in a range of 100° C. or higher and 300° C. or lower, preferably, 100° C. or higher and 250° C. or lower, and hydrothermally treated for one hour or longer and 72 hours or shorter, thereby obtaining the LixFe1−y−zAyMzPO4 particle.

In this case, the particle diameter of the LixFe1−y−zAyMzPO4 particle can be controlled to a desired size by adjusting the temperature and the time during the hydrothermal treatment.

Next, the LixFe1−y−zAyMzPO4 particle is dispersed in a water solvent including a carbon source, thereby preparing a raw material slurry β.

Next, this raw material slurry β is dried, granulated, and then heated at a temperature in a range of 500° C. or higher and 1,000° C. or lower, preferably, 500° C. or higher and 800° C. or lower for one hour or longer and 100 hours or shorter, the surface of the LixFe1−y−zAyMzPO4 particle (primary particle) is coated with a carbonaceous film, thereby obtaining the cathode material for a lithium ion secondary battery of the present embodiment. Here, in the case of heating the raw material slurry at a temperature lower than 500° C., the carbonaceous film is insufficiently carbonized, and the conductivity significantly decreases, which is not preferable. On the other hand, in the case of heating the raw material slurry at a temperature exceeding 1,000° C., some of lithium volatilizes, and the battery capacity decreases, which is not preferable.

“Carbon Source”

The carbon source is not particularly limited as long as the carbon source is an organic compound capable of forming a carbonaceous film on the surface of the central particle.

The organic compound is preferably a compound that is soluble in water or dispersible in water.

Examples thereof include salicylic acid, catechol, hydroquinone, resorcinol, pyrogallol, phloroglucinol, hexahydroxybenzene, benzoic acid, phthalic acid, terephthalic acid, phenylalanine, water dispersible phenolic resins and the like, sugars such as sucrose, glucose, and lactose, carboxylic acids such as malic acid and citric acid, unsaturated monohydric alcohols such as allyl alcohol and propargyl alcohol, ascorbic acid, polyvinyl alcohol, and the like, and it is possible to use one organic compound or a mixture of two or more organic compounds with a purity of carbon set to 42.00% or more.

In the method for manufacturing the cathode material for a lithium ion secondary battery of the present embodiment, an amount of the carbon source added (additive rate) is preferably 0.5% by mass or more and 15% by mass or less and more preferably 1% by mass or more and 10% by mass or less in a case in which a total mass of the central particle and the carbon source is set to 100% by mass.

When the amount of the carbon source added is less than 0.5% by mass, the mixing stability in the cathode material for a lithium ion secondary battery degrades, which is not preferable. On the other hand, when the amount of the carbon source added exceeds 15% by mass, a content of the cathode active material becomes relatively small, and battery characteristics degrade, which is not preferable.

In addition, in a case in which a plurality of kinds of organic compounds is used as the carbon source, amounts of the respective organic compounds blended are adjusted as described above so that the purity of carbon of the organic compounds reaches 42.00% or more and 60.00% or less.

[Cathode for Lithium Ion Secondary Battery]

A cathode for a lithium ion secondary battery of the present embodiment is a cathode for a lithium ion secondary battery including an electrode current collector and a cathode mixture layer (cathode) formed on the electrode current collector, in which the cathode mixture layer contains the cathode material for a lithium ion secondary battery of the present embodiment.

That is, the cathode for a lithium ion secondary battery of the present embodiment is a cathode for a lithium ion secondary battery obtained by forming the cathode mixture layer on one main surface of the electrode current collector using the cathode material for a lithium ion secondary battery of the present embodiment.

A method for manufacturing the cathode for a lithium ion secondary battery of the present embodiment is not particularly limited as long as the cathode can be formed on one main surface of the electrode current collector using the cathode material for a lithium ion secondary battery of the present embodiment. As the method for manufacturing the cathode for a lithium ion secondary battery of the present embodiment, for example, the following method is exemplified.

First, a cathode material paste for a lithium ion secondary battery is prepared by mixing the cathode material for a lithium ion secondary battery of the present embodiment, a binder, a conductive auxiliary agent, and a solvent.

“Binder”

The binder is not particularly limited as long as the binder can be used in a water system. For example, at least one selected from the group of polyethylene, polypropylene, polyethylene terephthalate, polymethyl methacrylate, vinyl acetate copolymers, styrene-butadiene-based latex, acrylic latex, acrylonitrile-butadiene-based latex, fluorine-based latex, silicone-based latex, and the like is exemplified.

A content rate of the binder in the cathode material paste for a lithium ion secondary battery is preferably 1% by mass or more and 10% by mass or less and more preferably 2% by mass or more and 6% by mass or less in a case in which a total mass of the cathode material for a lithium ion secondary battery of the present embodiment, the binder, and the conductive auxiliary agent is set to 100% by mass.

“Conductive Auxiliary Agent”

The conductive auxiliary agent is not particularly limited, and, for example, at least one selected from a group of fibrous carbon such as acetylene black, ketjen black, furnace black, vapor grown carbon fiber (VGCF), and carbon nanotube is used.

A content rate of the conductive auxiliary agent in the cathode material paste for a lithium ion secondary battery is preferably 1% by mass or more and 15% by mass or less and more preferably 3% by mass or more and 10% by mass or less in a case in which the total mass of the cathode material for a lithium ion secondary battery of the present embodiment, the binder, and the conductive auxiliary agent is set to 100% by mass.

“Solvent”

To the cathode material for a lithium ion secondary battery including the cathode material for a lithium ion secondary battery of the present embodiment, a solvent may be appropriately added in order to facilitate the application to an application target such as the current collector.

A main solvent is water, but the cathode material paste for a lithium ion secondary battery may contain a water-based solvent such as an alcohol, a glycol, or an ether as long as the characteristics of the cathode material for a lithium ion secondary battery of the present embodiment are not lost.

A content rate of the solvent in the cathode material paste for a lithium ion secondary battery is preferably 60 parts by mass or more and 400 parts by mass or less and more preferably 80 parts by mass or more and 300 parts by mass or less in a case in which a total mass of the cathode material for a lithium ion secondary battery of the present embodiment, the binder, and the conductive auxiliary agent is set to 100 parts by mass.

When the cathode material paste for a lithium ion secondary battery contains the solvent in the above-described range, it is possible to obtain a cathode material paste for a lithium ion secondary battery having an excellent electrode-forming property and excellent battery characteristics.

A method for mixing the cathode material for a lithium ion secondary battery of the present embodiment, the binder, the conductive auxiliary agent, and the solvent is not particularly limited as long as these components can be uniformly mixed together. Examples thereof include methods in which a kneader such as a ball mill, a sand mill, a planetary (sun-and-planet-type) mixer, a paint shaker, or a homogenizer is used.

Next, the cathode material paste for a lithium ion secondary battery is applied onto one main surface of the electrode current collector to form a coated film, and this coated film is dried and bonded by pressurization, whereby a cathode for a lithium ion secondary battery in which the cathode mixture layer is formed on one main surface of the electrode current collector can be obtained.

According to the cathode for a lithium ion secondary battery of the present embodiment, the cathode material for a lithium ion secondary battery of the present embodiment is contained, and thus it is possible to provide a cathode for a lithium ion secondary battery having a low overvoltage.

[Lithium Ion Secondary Battery]

A lithium ion secondary battery of the present embodiment includes a cathode made of the cathode for a lithium ion secondary battery of the present embodiment, an anode, a separator, and an electrolyte.

In the lithium ion secondary battery of the present embodiment, the anode, the electrolyte, the separator, and the like are not particularly limited.

As the anode, for example, an anode material such as metallic Li, a carbon material, a Li alloy, or Li₄Ti₅O₁₂ can be used.

In addition, instead of the electrolyte and the separator, a solid electrolyte may be used.

The electrolyte can be produced by, for example, mixing ethylene carbonate (EC) and ethyl methyl carbonate (EMC) so that a volume ratio therebetween reached 1:1 and dissolving a lithium hexafluorophosphate (LiPF6) in the obtained solvent mixture so that a concentration reaches, for example, 1 mol/dm³.

As the separator, for example, porous propylene can be used.

In the lithium ion secondary battery of the present embodiment, the cathode for a lithium ion secondary battery of the present embodiment is used, and thus the capacity is high and the energy density is high.

According to the lithium ion secondary battery of the present embodiment, the cathode for a lithium ion secondary battery of the present embodiment is provided, and thus it is possible to provide a lithium ion secondary battery having a low overvoltage.

### EXAMPLES

Hereinafter, the present invention will be more specifically described using examples and comparative examples, but the present invention is not limited to the following examples.

### Example 1

Phosphoric acid (H3PO4) (2.00 mol), lithium hydroxide (LiOH) (6.00 mol), iron (II) sulfate (FeSO4) (1.96 mol), iron (III) phosphate (FePO4) (0.04 mol), and water were mixed together so that a total amount reached 4 L, thereby preparing a homogeneous slurry-form mixture.

Next, this mixture was stored in a pressure-resistant airtight container having a capacity of 8 L and hydrothermally synthesized at 190° C. for 10 hours, thereby generating a precipitate.

Next, this precipitate was cleaned with water, thereby obtaining a cake-form cathode active material.

Next, polyethylene glycol (5 g) as an organic compound and zirconia balls having a diameter of 1 mm as a medium particle were added to this cathode active material (100 g in terms of solid content), and a dispersion treatment was carried out for one hour in a beads mill, thereby preparing a homogeneous slurry.

Next, this slurry was sprayed and dried in the atmosphere at 180° C., thereby obtaining a granulated body of the cathode active material coated with an organic substance.

The obtained granulated body was calcinated in a non-oxidative gas atmosphere (540° C.) for 40 hours and then held at 40° C. for 30 minutes, thereby obtaining a cathode material A1 of Example 1.

[Production of Lithium Ion Secondary Battery]

The cathode material A1, polyvinylidene fluoride (PVdF) as a binding material, and acetylene black (AB) as a conductive auxiliary agent were added to N-methyl-2-pyrrolidone (NMP) that was a solvent so that a mass ratio in a paste reached 90:5:5 (cathode material A1:AB:PVdF) and mixed together, thereby preparing a cathode material paste (for a cathode).

Next, this cathode material paste was applied on a surface of a 30 μm-thick aluminum foil (electrode current collector) to form a coated film, and the coated film was dried, thereby forming a cathode mixture layer on the surface of the aluminum foil. A thickness of the cathode mixture layer was adjusted so that a capacity ratio between a cathode and an anode reached 1.2 (anode/cathode).

After that, the cathode mixture layer was pressurized at a predetermined pressure so that a cathode density reached 1.8 g/mL, and then a square piece having a cathode area of 9 cm² was cut out by punching using a molder, thereby producing a cathode of Example 1.

Next, natural graphite as an anode active material, styrene butadiene latex (SBR) as a binder, and carboxymethyl cellulose (CMC) as a viscosity-adjusting material were added to pure water that was a solvent so that natural graphite:SBR:CMC reached 98:1:1 in terms of a mass ratio of a paste and mixed together, thereby preparing an anode material paste (for an anode).

The prepared anode material paste (for an anode) was applied on a surface of a 10 μm-thick copper foil (current collector) to form a coated film, and this coated film was dried, thereby forming an anode mixture layer on the surface of the copper foil. An application thickness was adjusted so that a weight per unit area of the anode mixture layer reached 4.4 mg/cm².

After that, the anode mixture layer was pressurized at a predetermined pressure so that an anode density reached 1.42 g/mL, and then a square piece having an anode area of 9.6 cm² was cut out by punching using a molder, thereby producing an anode of Example 1.

The produced cathode and anode were caused to face each other through a 25 m-thick separator made of porous polypropylene, immersed in a 1 mol/L of LiPF6 solution (0.5 mL) as an electrolyte, and then sealed with a laminate film, thereby producing a lithium ion secondary battery of Example 1. As the LiPF6 solution, a solution obtained by mixing ethylene carbonate and ethyl methyl carbonate so that a volume ratio therebetween reached 1:1 was used.

### Example 2

A cathode material A2 of Example 2 was obtained in the same manner as in Example 1 except for the fact that phosphoric acid (H3PO4) (2.00 mol), lithium hydroxide (LiOH) (6.00 mol), iron (II) sulfate (FeSO4) (1.94 mol), iron (III) phosphate (FePO4) (0.06 mol), and water were mixed together so that the total amount reached 4 L, thereby preparing a homogeneous slurry-form mixture.

A lithium ion secondary battery of Example 2 was produced in the same manner as in Example 1 except for the fact that the cathode material A2 was used.

### Example 3

A cathode material A3 of Example 3 was obtained in the same manner as in Example 1 except for the fact that phosphoric acid (H3PO4) (2.00 mol), lithium hydroxide (LiOH) (6.00 mol), iron (II) sulfate (FeSO4) (1.92 mol), iron (III) phosphate (FePO4) (0.08 mol), and water were mixed together so that the total amount reached 4 L, thereby preparing a homogeneous slurry-form mixture.

A lithium ion secondary battery of Example 3 was produced in the same manner as in Example 1 except for the fact that the cathode material A3 was used.

### Example 4

A cathode material A4 of Example 4 was obtained in the same manner as in Example 1 except for the fact that phosphoric acid (H3PO4) (2.00 mol), lithium hydroxide (LiOH) (6.00 mol), iron (II) sulfate (FeSO4) (1.90 mol), iron (III) phosphate (FePO4) (0.10 mol), and water were mixed together so that the total amount reached 4 L, thereby preparing a homogeneous slurry-form mixture.

A lithium ion secondary battery of Example 4 was produced in the same manner as in Example 1 except for the fact that the cathode material A4 was used.

### Example 5

A cathode material A5 of Example 5 was obtained in the same manner as in Example 1 except for the fact that phosphoric acid (H3PO4) (2.00 mol), lithium hydroxide (LiOH) (6.00 mol), iron (II) sulfate (FeSO4) (1.86 mol), iron (III) phosphate (FePO4) (0.14 mol), and water were mixed together so that the total amount reached 4 L, thereby preparing a homogeneous slurry-form mixture.

A lithium ion secondary battery of Example 5 was produced in the same manner as in Example 1 except for the fact that the cathode material A5 was used.

### Example 6

A cathode material A6 of Example 6 was obtained in the same manner as in Example 1 except for the fact that phosphoric acid (H3PO4) (2.00 mol), lithium hydroxide (LiOH) (6.00 mol), iron (II) sulfate (FeSO4) (1.82 mol), iron (III) phosphate (FePO4) (0.18 mol), and water were mixed together so that the total amount reached 4 L, thereby preparing a homogeneous slurry-form mixture.

A lithium ion secondary battery of Example 6 was produced in the same manner as in Example 1 except for the fact that the cathode material A6 was used.

### Example 7

A cathode material A7 of Example 7 was obtained in the same manner as in Example 1 except for the fact that phosphoric acid (H3PO4) (2.00 mol), lithium hydroxide (LiOH) (6.00 mol), iron (II) sulfate (FeSO4) (1.78 mol), iron (III) phosphate (FePO4) (0.22 mol), and water were mixed together so that the total amount reached 4 L, thereby preparing a homogeneous slurry-form mixture.

A lithium ion secondary battery of Example 7 was produced in the same manner as in Example 1 except for the fact that the cathode material A7 was used.

### Example 8

Phosphoric acid (H3PO4) (2.00 mol), lithium hydroxide (LiOH) (6.00 mol), iron (II) sulfate (FeSO4) (0.30 mol), manganese (II) sulfate (MnSO4) (1.60 mol), iron (III) phosphate (FePO4) (0.10 mol), and water were mixed together so that the total amount reached 4 L, thereby preparing a homogeneous slurry-form mixture.

Next, this mixture was stored in a pressure-resistant airtight container having a capacity of 8 L and hydrothermally synthesized at 120° C. for eight hours, thereby generating a precipitate.

Next, this precipitate was cleaned with water, thereby obtaining a cake-form cathode active material.

Next, polyethylene glycol (10 g) as an organic compound and zirconia balls having a diameter of 0.5 mm as a medium particle were added to this cathode active material (100 g in terms of solid content), and a dispersion treatment was carried out for three hours in a beads mill, thereby preparing a homogeneous slurry.

Next, this slurry was sprayed and dried in the atmosphere at 160° C., thereby obtaining a granulated body of the cathode active material coated with an organic substance.

The obtained granulated body was calcinated in a non-oxidative gas atmosphere (540° C.) for 40 hours and then held at 40° C. for 30 minutes, thereby obtaining a cathode material A8 of Example 8.

A lithium ion secondary battery of Example 8 was produced in the same manner as in Example 1 except for the fact that the cathode material A8 was used.

### Example 9

Phosphoric acid (H3PO4) (2.00 mol), lithium hydroxide (LiOH) (5.70 mol), iron (II) sulfate (FeSO4) (0.70 mol), manganese (II) sulfate (MnSO4) (1.20 mol), iron (III) phosphate (FePO4) (0.10 mol), and water were mixed together so that the total amount reached 4 L, thereby preparing a homogeneous slurry-form mixture.

Next, this mixture was stored in a pressure-resistant airtight container having a capacity of 8 L and hydrothermally synthesized at 120° C. for eight hours, thereby generating a precipitate.

Next, this precipitate was cleaned with water, thereby obtaining a cake-form cathode active material.

Next, polyethylene glycol (10 g) as an organic compound and zirconia balls having a diameter of 0.5 mm as a medium particle were added to this cathode active material (100 g in terms of solid content), and a dispersion treatment was carried out for three hours in a beads mill, thereby preparing a homogeneous slurry.

Next, this slurry was sprayed and dried in the atmosphere at 160° C., thereby obtaining a granulated body of the cathode active material coated with an organic substance.

The obtained granulated body was calcinated in a non-oxidative gas atmosphere (540° C.) for 40 hours and then held at 40° C. for 30 minutes, thereby obtaining a cathode material A9 of Example 9.

A lithium ion secondary battery of Example 9 was produced in the same manner as in Example 1 except for the fact that the cathode material A9 was used.

### Example 10

Phosphoric acid (H3PO4) (2.00 mol), lithium hydroxide (LiOH) (5.70 mol), iron (II) sulfate (FeSO4) (1.10 mol), manganese (II) sulfate (MnSO4) (0.80 mol), iron (III) phosphate (FePO4) (0.10 mol), and water were mixed together so that the total amount reached 4 L, thereby preparing a homogeneous slurry-form mixture.

Next, this mixture was stored in a pressure-resistant airtight container having a capacity of 8 L and hydrothermally synthesized at 120° C. for eight hours, thereby generating a precipitate.

Next, this precipitate was cleaned with water, thereby obtaining a cake-form cathode active material.

Next, polyethylene glycol (10 g) as an organic compound and zirconia balls having a diameter of 0.5 mm as a medium particle were added to this cathode active material (100 g in terms of solid content), and a dispersion treatment was carried out for three hours in a beads mill, thereby preparing a homogeneous slurry.

Next, this slurry was sprayed and dried in the atmosphere at 160° C., thereby obtaining a granulated body of the cathode active material coated with an organic substance.

The obtained granulated body was calcinated in a non-oxidative gas atmosphere (540° C.) for 40 hours and then held at 40° C. for 30 minutes, thereby obtaining a cathode material A10 of Example 10.

A lithium ion secondary battery of Example 10 was produced in the same manner as in Example 1 except for the fact that the cathode material A10 was used.

### Example 11

Phosphoric acid (H3PO4) (2.00 mol), lithium hydroxide (LiOH) (5.70 mol), iron (II) sulfate (FeSO4) (1.50 mol), manganese (II) sulfate (MnSO4) (0.40 mol), iron (III) phosphate (FePO4) (0.10 mol), and water were mixed together so that the total amount reached 4 L, thereby preparing a homogeneous slurry-form mixture.

Next, this mixture was stored in a pressure-resistant airtight container having a capacity of 8 L and hydrothermally synthesized at 120° C. for eight hours, thereby generating a precipitate.

Next, this precipitate was cleaned with water, thereby obtaining a cake-form cathode active material.

Next, polyethylene glycol (10 g) as an organic compound and zirconia balls having a diameter of 0.5 mm as a medium particle were added to this cathode active material (100 g in terms of solid content), and a dispersion treatment was carried out for three hours in a beads mill, thereby preparing a homogeneous slurry.

Next, this slurry was sprayed and dried in the atmosphere at 160° C., thereby obtaining a granulated body of the cathode active material coated with an organic substance.

The obtained granulated body was calcinated in a non-oxidative gas atmosphere (540° C.) for 40 hours and then held at 40° C. for 30 minutes, thereby obtaining a cathode material A11 of Example 11.

A lithium ion secondary battery of Example 11 was produced in the same manner as in Example 1 except for the fact that the cathode material A11 was used.

### Example 12

Phosphoric acid (H3PO4) (2.00 mol), lithium hydroxide (LiOH) (5.70 mol), iron (II) sulfate (FeSO4) (0.40 mol), manganese (II) sulfate (MnSO4) (1.40 mol), zinc sulfate (ZnSO4) (0.10 mol), iron (III) phosphate (FePO4) (0.10 mol), and water were mixed together so that the total amount reached 4 L, thereby preparing a homogeneous slurry-form mixture.

Next, this mixture was stored in a pressure-resistant airtight container having a capacity of 8 L and hydrothermally synthesized at 120° C. for eight hours, thereby generating a precipitate.

Next, this precipitate was cleaned with water, thereby obtaining a cake-form cathode active material.

Next, polyethylene glycol (10 g) as an organic compound and zirconia balls having a diameter of 0.5 mm as a medium particle were added to this cathode active material (100 g in terms of solid content), and a dispersion treatment was carried out for three hours in a beads mill, thereby preparing a homogeneous slurry.

Next, this slurry was sprayed and dried in the atmosphere at 160° C., thereby obtaining a granulated body of the cathode active material coated with an organic substance.

The obtained granulated body was calcinated in a non-oxidative gas atmosphere (540° C.) for 40 hours and then held at 40° C. for 30 minutes, thereby obtaining a cathode material A12 of Example 12.

A lithium ion secondary battery of Example 12 was produced in the same manner as in Example 1 except for the fact that the cathode material A12 was used.

### Example 13

Phosphoric acid (H3PO4) (2.00 mol), lithium hydroxide (LiOH) (5.70 mol), iron (II) sulfate (FeSO4) (0.40 mol), manganese (II) sulfate (MnSO4) (1.40 mol), magnesium sulfate (MgSO4) (0.10 mol), iron (III) phosphate (FePO4) (0.10 mol), and water were mixed together so that the total amount reached 4 L, thereby preparing a homogeneous slurry-form mixture.

Next, this mixture was stored in a pressure-resistant airtight container having a capacity of 8 L and hydrothermally synthesized at 120° C. for eight hours, thereby generating a precipitate.

Next, this precipitate was cleaned with water, thereby obtaining a cake-form cathode active material.

Next, polyethylene glycol (10 g) as an organic compound and zirconia balls having a diameter of 0.5 mm as a medium particle were added to this cathode active material (100 g in terms of solid content), and a dispersion treatment was carried out for three hours in a beads mill, thereby preparing a homogeneous slurry.

Next, this slurry was sprayed and dried in the atmosphere at 160° C., thereby obtaining a granulated body of the cathode active material coated with an organic substance.

The obtained granulated body was calcinated in a non-oxidative gas atmosphere (540° C.) for 40 hours and then held at 40° C. for 30 minutes, thereby obtaining a cathode material A13 of Example 13.

A lithium ion secondary battery of Example 13 was produced in the same manner as in Example 1 except for the fact that the cathode material A13 was used.

### Example 14

Phosphoric acid (H3PO4) (2.00 mol), lithium hydroxide (LiOH) (5.70 mol), iron (II) sulfate (FeSO4) (0.40 mol), manganese (II) sulfate (MnSO4) (1.40 mol), nickel (II) sulfate (NiSO4) (0.10 mol), iron (III) phosphate (FePO4) (0.10 mol), and water were mixed together so that the total amount reached 4 L, thereby preparing a homogeneous slurry-form mixture.

Next, this mixture was stored in a pressure-resistant airtight container having a capacity of 8 L and hydrothermally synthesized at 120° C. for eight hours, thereby generating a precipitate.

Next, this precipitate was cleaned with water, thereby obtaining a cake-form cathode active material.

Next, polyethylene glycol (10 g) as an organic compound and zirconia balls having a diameter of 0.5 mm as a medium particle were added to this cathode active material (100 g in terms of solid content), and a dispersion treatment was carried out for three hours in a beads mill, thereby preparing a homogeneous slurry.

Next, this slurry was sprayed and dried in the atmosphere at 160° C., thereby obtaining a granulated body of the cathode active material coated with an organic substance.

The obtained granulated body was calcinated in a non-oxidative gas atmosphere (540° C.) for 40 hours and then held at 40° C. for 30 minutes, thereby obtaining a cathode material A14 of Example 14.

A lithium ion secondary battery of Example 14 was produced in the same manner as in Example 1 except for the fact that the cathode material A14 was used.

### Example 15

Phosphoric acid (H3PO4) (2.00 mol), lithium hydroxide (LiOH) (5.70 mol), iron (II) sulfate (FeSO4) (0.40 mol), manganese (II) sulfate (MnSO4) (1.40 mol), cobalt sulfate (COSO4) (0.10 mol), iron (III) phosphate (FePO4) (0.10 mol), and water were mixed together so that the total amount reached 4 L, thereby preparing a homogeneous slurry-form mixture.

Next, this mixture was stored in a pressure-resistant airtight container having a capacity of 8 L and hydrothermally synthesized at 120° C. for eight hours, thereby generating a precipitate.

Next, this precipitate was cleaned with water, thereby obtaining a cake-form cathode active material.

Next, polyethylene glycol (10 g) as an organic compound and zirconia balls having a diameter of 0.5 mm as a medium particle were added to this cathode active material (100 g in terms of solid content), and a dispersion treatment was carried out for three hours in a beads mill, thereby preparing a homogeneous slurry.

Next, this slurry was sprayed and dried in the atmosphere at 160° C., thereby obtaining a granulated body of the cathode active material coated with an organic substance.

The obtained granulated body was calcinated in a non-oxidative gas atmosphere (540° C.) for 40 hours and then held at 40° C. for 30 minutes, thereby obtaining a cathode material A15 of Example 15.

A lithium ion secondary battery of Example 15 was produced in the same manner as in Example 1 except for the fact that the cathode material A15 was used.

### Example 16

A cathode material A16 of Example 16 was obtained in the same manner as in Example 3 except for the fact that the amount of polyethylene glycol added as the organic compound was set to 2.5 g.

A lithium ion secondary battery of Example 16 was produced in the same manner as in Example 1 except for the fact that the cathode material A16 was used.

### Example 17

A cathode material A17 of Example 17 was obtained in the same manner as in Example 3 except for the fact that the amount of polyethylene glycol added as the organic compound was set to 2.0 g.

A lithium ion secondary battery of Example 17 was produced in the same manner as in Example 1 except for the fact that the cathode material A17 was used.

### Example 18

A cathode material A18 of Example 18 was obtained in the same manner as in Example 3 except for the fact that the amount of polyethylene glycol added as the organic compound was set to 1.5 g.

A lithium ion secondary battery of Example 18 was produced in the same manner as in Example 1 except for the fact that the cathode material A18 was used.

### Example 19

A cathode material A19 of Example 19 was obtained in the same manner as in Example 15 except for the fact that the amount of polyethylene glycol added as the organic compound was set to 14.0 g.

A lithium ion secondary battery of Example 19 was produced in the same manner as in Example 1 except for the fact that the cathode material A19 was used.

### Example 20

A cathode material A20 of Example 20 was obtained in the same manner as in Example 15 except for the fact that the amount of polyethylene glycol added as the organic compound was set to 13.0 g.

A lithium ion secondary battery of Example 20 was produced in the same manner as in Example 1 except for the fact that the cathode material A20 was used.

### Example 21

A cathode material A21 of Example 21 was obtained in the same manner as in Example 15 except for the fact that the amount of polyethylene glycol added as the organic compound was set to 12.0 g.

A lithium ion secondary battery of Example 21 was produced in the same manner as in Example 1 except for the fact that the cathode material A21 was used.

### Comparative Example 1

A cathode material B1 of Comparative Example 1 was obtained in the same manner as in Example 1 except for the fact that phosphoric acid (H3PO4) (2.00 mol), lithium hydroxide (LiOH) (6.00 mol), iron (II) sulfate (FeSO4) (2.00 mol), and water were mixed together so that the total amount reached 4 L, thereby preparing a homogeneous slurry-form mixture.

A lithium ion secondary battery of Comparative Example 1 was produced in the same manner as in Example 1 except for the fact that the cathode material B1 was used.

### Comparative Example 2

A cathode material B2 of Comparative Example 2 was obtained in the same manner as in Example 1 except for the fact that phosphoric acid (H3PO4) (2.00 mol), lithium hydroxide (LiOH) (6.00 mol), iron (II) sulfate (FeSO4) (1.98 mol), iron (III) phosphate (FePO4) (0.02 mol), and water were mixed together so that the total amount reached 4 L, thereby preparing a homogeneous slurry-form mixture.

A lithium ion secondary battery of Comparative Example 2 was produced in the same manner as in Example 1 except for the fact that the cathode material B2 was used.

### Comparative Example 3

A cathode material B3 of Comparative Example 3 was obtained in the same manner as in Example 1 except for the fact that phosphoric acid (H3PO4) (2.00 mol), lithium hydroxide (LiOH) (6.00 mol), iron (II) sulfate (FeSO4) (1.74 mol), iron (III) phosphate (FePO4) (0.26 mol), and water were mixed together so that the total amount reached 4 L, thereby preparing a homogeneous slurry-form mixture.

A lithium ion secondary battery of Comparative Example 3 was produced in the same manner as in Example 1 except for the fact that the cathode material B3 was used.

### Comparative Example 4

Phosphoric acid (H3PO4) (2.00 mol), lithium hydroxide (LiOH) (6.00 mol), iron (II) sulfate (FeSO4) (0.40 mol), manganese (II) sulfate (MnSO4) (1.60 mol), and water were mixed together so that the total amount reached 4 L, thereby preparing a homogeneous slurry-form mixture.

Next, this mixture was stored in a pressure-resistant airtight container having a capacity of 8 L and hydrothermally synthesized at 120° C. for eight hours, thereby generating a precipitate.

Next, this precipitate was cleaned with water, thereby obtaining a cake-form cathode active material.

Next, polyethylene glycol (10 g) as an organic compound and zirconia balls having a diameter of 0.5 mm as a medium particle were added to this cathode active material (100 g in terms of solid content), and a dispersion treatment was carried out for three hours in a beads mill, thereby preparing a homogeneous slurry.

Next, this slurry was sprayed and dried in the atmosphere at 160° C., thereby obtaining a granulated body of the cathode active material coated with an organic substance.

The obtained granulated body was calcinated in a non-oxidative gas atmosphere (540° C.) for 40 hours and then held at 40° C. for 30 minutes, thereby obtaining a cathode material B4 of Comparative Example 4.

A lithium ion secondary battery of Comparative Example 4 was produced in the same manner as in Example 1 except for the fact that the cathode material B4 was used.

### Comparative Example 5

Phosphoric acid (H3PO4) (2.00 mol), lithium hydroxide (LiOH) (6.00 mol), iron (II) sulfate (FeSO4) (0.80 mol), manganese (II) sulfate (MnSO4) (1.20 mol), and water were mixed together so that the total amount reached 4 L, thereby preparing a homogeneous slurry-form mixture.

Next, this mixture was stored in a pressure-resistant airtight container having a capacity of 8 L and hydrothermally synthesized at 120° C. for eight hours, thereby generating a precipitate.

Next, this precipitate was cleaned with water, thereby obtaining a cake-form cathode active material.

Next, polyethylene glycol (10 g) as an organic compound and zirconia balls having a diameter of 0.5 mm as a medium particle were added to this cathode active material (100 g in terms of solid content), and a dispersion treatment was carried out for three hours in a beads mill, thereby preparing a homogeneous slurry.

Next, this slurry was sprayed and dried in the atmosphere at 160° C., thereby obtaining a granulated body of the cathode active material coated with an organic substance.

The obtained granulated body was calcinated in a non-oxidative gas atmosphere (540° C.) for 40 hours and then held at 40° C. for 30 minutes, thereby obtaining a cathode material B5 of Comparative Example 5.

A lithium ion secondary battery of Comparative Example 5 was produced in the same manner as in Example 1 except for the fact that the cathode material B5 was used.

### Comparative Example 6

Phosphoric acid (H3PO4) (2.00 mol), lithium hydroxide (LiOH) (6.00 mol), iron (II) sulfate (FeSO4) (1.20 mol), manganese (II) sulfate (MnSO4) (0.80 mol), and water were mixed together so that the total amount reached 4 L, thereby preparing a homogeneous slurry-form mixture.

Next, this mixture was stored in a pressure-resistant airtight container having a capacity of 8 L and hydrothermally synthesized at 120° C. for eight hours, thereby generating a precipitate.

Next, this precipitate was cleaned with water, thereby obtaining a cake-form cathode active material.

Next, polyethylene glycol (10 g) as an organic compound and zirconia balls having a diameter of 0.5 mm as a medium particle were added to this cathode active material (100 g in terms of solid content), and a dispersion treatment was carried out for three hours in a beads mill, thereby preparing a homogeneous slurry.

Next, this slurry was sprayed and dried in the atmosphere at 160° C., thereby obtaining a granulated body of the cathode active material coated with an organic substance.

The obtained granulated body was calcinated in a non-oxidative gas atmosphere (540° C.) for 40 hours and then held at 40° C. for 30 minutes, thereby obtaining a cathode material B6 of Comparative Example 6.

A lithium ion secondary battery of Comparative Example 6 was produced in the same manner as in Example 1 except for the fact that the cathode material B6 was used.

### Comparative Example 7

Phosphoric acid (H3PO4) (2.00 mol), lithium hydroxide (LiOH) (6.00 mol), iron (II) sulfate (FeSO4) (1.60 mol), manganese (II) sulfate (MnSO4) (0.40 mol), and water were mixed together so that the total amount reached 4 L, thereby preparing a homogeneous slurry-form mixture.

Next, this mixture was stored in a pressure-resistant airtight container having a capacity of 8 L and hydrothermally synthesized at 120° C. for eight hours, thereby generating a precipitate.

Next, this precipitate was cleaned with water, thereby obtaining a cake-form cathode active material.

Next, polyethylene glycol (10 g) as an organic compound and zirconia balls having a diameter of 0.5 mm as a medium particle were added to this cathode active material (100 g in terms of solid content), and a dispersion treatment was carried out for three hours in a beads mill, thereby preparing a homogeneous slurry.

Next, this slurry was sprayed and dried in the atmosphere at 160° C., thereby obtaining a granulated body of the cathode active material coated with an organic substance.

The obtained granulated body was calcinated in a non-oxidative gas atmosphere (540° C.) for 40 hours and then held at 40° C. for 30 minutes, thereby obtaining a cathode material B7 of Comparative Example 7.

A lithium ion secondary battery of Comparative Example 7 was produced in the same manner as in Example 1 except for the fact that the cathode material B7 was used.

### Comparative Example 8

Phosphoric acid (H3PO4) (2.00 mol), lithium hydroxide (LiOH) (6.00 mol), iron (II) sulfate (FeSO4) (0.50 mol), manganese (II) sulfate (MnSO4) (1.40 mol), zinc sulfate (ZnSO4) (0.1 mol), and water were mixed together so that the total amount reached 4 L, thereby preparing a homogeneous slurry-form mixture.

Next, this mixture was stored in a pressure-resistant airtight container having a capacity of 8 L and hydrothermally synthesized at 120° C. for eight hours, thereby generating a precipitate.

Next, this precipitate was cleaned with water, thereby obtaining a cake-form cathode active material.

Next, polyethylene glycol (10 g) as an organic compound and zirconia balls having a diameter of 0.5 mm as a medium particle were added to this cathode active material (100 g in terms of solid content), and a dispersion treatment was carried out for three hours in a beads mill, thereby preparing a homogeneous slurry.

Next, this slurry was sprayed and dried in the atmosphere at 160° C., thereby obtaining a granulated body of the cathode active material coated with an organic substance.

The obtained granulated body was calcinated in a non-oxidative gas atmosphere (540° C.) for 40 hours and then held at 40° C. for 30 minutes, thereby obtaining a cathode material B8 of Comparative Example 8.

A lithium ion secondary battery of Comparative Example 8 was produced in the same manner as in Example 1 except for the fact that the cathode material B8 was used.

### Comparative Example 9

Phosphoric acid (H3PO4) (2.00 mol), lithium hydroxide (LiOH) (6.00 mol), iron (II) sulfate (FeSO4) (0.50 mol), manganese (II) sulfate (MnSO4) (1.40 mol), magnesium sulfate (MgSO4) (0.10 mol), and water were mixed together so that the total amount reached 4 L, thereby preparing a homogeneous slurry-form mixture.

Next, this mixture was stored in a pressure-resistant airtight container having a capacity of 8 L and hydrothermally synthesized at 120° C. for eight hours, thereby generating a precipitate.

Next, this precipitate was cleaned with water, thereby obtaining a cake-form cathode active material.

Next, polyethylene glycol (10 g) as an organic compound and zirconia balls having a diameter of 0.5 mm as a medium particle were added to this cathode active material (100 g in terms of solid content), and a dispersion treatment was carried out for three hours in a beads mill, thereby preparing a homogeneous slurry.

Next, this slurry was sprayed and dried in the atmosphere at 160° C., thereby obtaining a granulated body of the cathode active material coated with an organic substance.

The obtained granulated body was calcinated in a non-oxidative gas atmosphere (540° C.) for 40 hours and then held at 40° C. for 30 minutes, thereby obtaining a cathode material B9 of Comparative Example 9.

A lithium ion secondary battery of Comparative Example 9 was produced in the same manner as in Example 1 except for the fact that the cathode material B9 was used.

### Comparative Example 10

Phosphoric acid (H3PO4) (2.00 mol), lithium hydroxide (LiOH) (6.00 mol), iron (II) sulfate (FeSO4) (0.50 mol), manganese (II) sulfate (MnSO4) (1.40 mol), nickel sulfate (NiSO4) (0.10 mol), and water were mixed together so that the total amount reached 4 L, thereby preparing a homogeneous slurry-form mixture.

Next, this mixture was stored in a pressure-resistant airtight container having a capacity of 8 L and hydrothermally synthesized at 120° C. for eight hours, thereby generating a precipitate.

Next, this precipitate was cleaned with water, thereby obtaining a cake-form cathode active material.

Next, polyethylene glycol (10 g) as an organic compound and zirconia balls having a diameter of 0.5 mm as a medium particle were added to this cathode active material (100 g in terms of solid content), and a dispersion treatment was carried out for three hours in a beads mill, thereby preparing a homogeneous slurry.

Next, this slurry was sprayed and dried in the atmosphere at 160° C., thereby obtaining a granulated body of the cathode active material coated with an organic substance.

The obtained granulated body was calcinated in a non-oxidative gas atmosphere (540° C.) for 40 hours and then held at 40° C. for 30 minutes, thereby obtaining a cathode material B10 of Comparative Example 10.

A lithium ion secondary battery of Comparative Example 10 was produced in the same manner as in Example 1 except for the fact that the cathode material B10 was used.

### Comparative Example 11

Phosphoric acid (H3PO4) (2.00 mol), lithium hydroxide (LiOH) (6.00 mol), iron (II) sulfate (FeSO4) (0.50 mol), manganese (II) sulfate (MnSO4) (1.40 mol), cobalt sulfate (CoSO4) (0.10 mol), and water were mixed together so that the total amount reached 4 L, thereby preparing a homogeneous slurry-form mixture.

Next, this mixture was stored in a pressure-resistant airtight container having a capacity of 8 L and hydrothermally synthesized at 120° C. for eight hours, thereby generating a precipitate.

Next, this precipitate was cleaned with water, thereby obtaining a cake-form cathode active material.

Next, polyethylene glycol (10 g) as an organic compound and zirconia balls having a diameter of 0.5 mm as a medium particle were added to this cathode active material (100 g in terms of solid content), and a dispersion treatment was carried out for three hours in a beads mill, thereby preparing a homogeneous slurry.

Next, this slurry was sprayed and dried in the atmosphere at 160° C., thereby obtaining a granulated body of the cathode active material coated with an organic substance.

The obtained granulated body was calcinated in a non-oxidative gas atmosphere (540° C.) for 40 hours and then held at 40° C. for 30 minutes, thereby obtaining a cathode material B1 of Comparative Example 11.

A lithium ion secondary battery of Comparative Example 11 was produced in the same manner as in Example 1 except for the fact that the cathode material B11 was used.

### Comparative Example 12

A cathode material B12 of Comparative Example 12 was obtained in the same manner as in Example 3 except for the fact that the amount of polyethylene glycol added as the organic compound was set to 1.0 g.

A lithium ion secondary battery of Comparative Example 12 was produced in the same manner as in Example 1 except for the fact that the cathode material B12 was used.

### Comparative Example 13

A cathode material B13 of Comparative Example 13 was obtained in the same manner as in Example 15 except for the fact that the amount of polyethylene glycol added as the organic compound was set to 15.0 g.

A lithium ion secondary battery of Comparative Example 13 was produced in the same manner as in Example 1 except for the fact that the cathode material B13 was used.

### Comparative Example 14

A cathode material B14 of Comparative Example 14 was obtained in the same manner as in Example 1 except for the fact that the amount of polyethylene glycol added as the organic compound was set to 1.0 g.

A lithium ion secondary battery of Comparative Example 14 was produced in the same manner as in Example 1 except for the fact that the cathode material B14 was used.

“Evaluation”

(1) Moessbauer Spectrum Measurement

A Moessbauer spectroscopic analysis by the Moessbauer spectroscopy was carried out on the cathode materials of Example 1 to Example 21 and Comparative Example 1 to Comparative Example 14. The Moessbauer spectrum was measured using a penetration method. The details will be described below.

Measurement method: Constant acceleration mode, room temperature, at normal pressure

Radiation source: 57Co/Rh matrix, 1.85 [GBq]

Rate axis calibration method: The central locations of four inside peaks out of six magnetic split peaks of a spectrum of a pure iron foil at room temperature were represented by X2, X3, X4, and X5 [channel] and obtained using the following expressions.

X0 [channel]=(X2+X3+X4+X5)/4

Γ[channel]=20.422/{0.0835(X5−X2)+0.8385(X4−X3)}

With an assumption that a spectrum obtained by the Moessbauer spectroscopic analysis can be approximated using a Lorentz-type theoretical linear expression, the peak full widths at half maximum of individual components are all equal to one another, peak heights in symmetric locations are equal to one another, and the spectrum is a theoretical linear addition, curve fitting was carried out, peak locations were specified, and the area intensities of the individual components were obtained. As the theoretical linear expression, Expression (1) was used.

In addition, the relative area ratios of the individual components when the square sum of the residual error was minimized in the least-square method was considered as the area intensity of the spectrum.

The area intensity of a spectrum having an isomer shift value in a range of 1.0 mm/sec or more and 1.4 mm/sec or less was represented by α, and the area intensity of a spectrum having an isomer shift value in a range of 0.3 mm/sec or more and 0.7 mm/sec or less was represented by β. The results are shown in Table 1 and Table 2.

(2) Content of Carbon Atom in Cathode Material

The content of a carbon atom in the cathode material was measured using a carbon/sulfur analyzer (trade name: EMIA-220V, manufactured by Horiba Ltd.). The results are shown in Table 1 and Table 2.

(3) Evaluation of Lithium Ion Secondary Battery (Discharge Capacity)

On the lithium ion secondary battery, constant current charge was carried out at an environment temperature of 25° C. and an electric current value of 0.1 C until the battery voltage reached 4.3 V, then, the constant current charge was switched to constant voltage charge, and the charging was ended when the electric current value reached 0.01 C. After that, a discharge capacity when constant current charge was carried out until the battery voltage reached 2.5 V at an electric current value of 10 C was considered as a 10 C discharge capacity.

In addition, in a case in which the 10 C discharge capacity improved by 20 mAh/g or more compared with that of the battery to which a trivalent Fe source was not added, the battery was evaluated as A, in a case in which the 10 C discharge capacity improved by less than 20 mAh/g and 10 mAh/g or more compared with that of the battery to which a trivalent Fe source was not added, the battery was evaluated as B, in a case in which the 10 C discharge capacity improved by less than 10 mAh/g and 1 mAh/g or more compared with that of the battery to which a trivalent Fe source was not added, the battery was evaluated as C, and, in a case in which the 10 C discharge capacity did not improve compared with that of the battery to which a trivalent Fe source was not added, the battery was evaluated as D. The results are shown in Table 1 and Table 2.

TABLE 1

| | | Spectrum 1 | | | Spectrum 2 | | |
|---|---|---|---|---|---|---|---|
| | | Isomer | Quadrupolar | Area | Isomer | Quadrupolar | Area |
| | | shift | split | intensity | shift | split | intensity |
| | Chemical formula | [mm/s] | [mm/s] | α | [mm/s] | [mm/s] | β |
| Example 1 | LiFeP0₄ | 1.22 | 2.96 | 0.985 | 0.51 | 0.58 | 0.015 |
| Example 2 | LiFeP0₄ | 1.23 | 2.97 | 0.977 | 0.54 | 0.55 | 0.023 |
| Example 3 | LiFeP0₄ | 1.22 | 2.97 | 0.966 | 0.53 | 0.54 | 0.034 |
| Example 4 | LiFeP0₄ | 1.23 | 2.97 | 0.953 | 0.52 | 0.56 | 0.047 |
| Example 5 | LiFeP0₄ | 1.22 | 2.96 | 0.938 | 0.53 | 0.55 | 0.062 |
| Example 6 | LiFeP0₄ | 1.23 | 2.97 | 0.927 | 0.50 | 0.54 | 0.073 |
| Example 7 | LiFeP0₄ | 1.23 | 2.97 | 0.904 | 0.52 | 0.57 | 0.096 |
| Example 8 | LiFe_{0.2}Mn_{0.8}P0₄ | 1.24 | 2.96 | 0.817 | 0.36 | 0.94 | 0.183 |
| Example 9 | LiFe_{0.4}Mn_{0.6}P0₄ | 1.25 | 2.96 | 0.913 | 0.41 | 0.84 | 0.087 |
| Example 10 | LiFe_{0.6}Mn_{0.4}P0₄ | 1.24 | 2.97 | 0.945 | 0.45 | 0.91 | 0.055 |
| Example 11 | LiFe_{0.8}Mn_{0.2}P0₄ | 1.23 | 2.97 | 0.956 | 0.49 | 0.77 | 0.044 |
| Example 12 | LiFe_{0.25}Mn_{0.7}Zn_{0.05}P0₄ | 1.25 | 2.96 | 0.779 | 0.64 | 0.43 | 0.221 |
| Example 13 | LiFe_{0.25}Mn_{0.7}Mg_{0.05}P0₄ | 1.25 | 2.97 | 0.787 | 0.55 | 0.52 | 0.213 |
| Example 14 | LiFe_{0.25}Mn_{0.7}Ni_{0.05}P0₄ | 1.25 | 2.96 | 0.796 | 0.39 | 1.07 | 0.204 |
| Example 15 | LiFe_{0.25}Mn_{0.7}Co_{0.05}P0₄ | 1.26 | 2.96 | 0.778 | 0.43 | 0.76 | 0.222 |
| Example 16 | LiFeP0₄ | 1.22 | 2.97 | 0.962 | 0.55 | 0.55 | 0.038 |
| Example 17 | LiFeP0₄ | 1.22 | 2.96 | 0.959 | 0.53 | 0.54 | 0.041 |
| Example 18 | LiFeP0₄ | 1.23 | 2.96 | 0.956 | 0.54 | 0.56 | 0.044 |
| Example 19 | LiFe_{0.25}Mn_{0.7}Co_{0.05}P0₄ | 1.24 | 2.96 | 0.793 | 0.45 | 0.72 | 0.207 |
| Example 20 | LiFe_{0.25}Mn_{0.7}Co_{0.05}P0₄ | 1.25 | 2.97 | 0.788 | 0.44 | 0.72 | 0.212 |
| Example 21 | LiFe_{0.25}Mn_{0.7}Co_{0.05}P0₄ | 1.24 | 2.97 | 0.783 | 0.43 | 0.74 | 0.217 |

| | | | | Content | 10 C | |
|---|---|---|---|---|---|---|
| | | | | of carbon | discharge | |
| | | | β/(β + α) × | element | capacity | Battery |
| | y | z | (1 − y − Z) | [% by weight] | {mAh/g} | evaluation |
| Example 1 | 0 | 0 | 0.015 | 0.84 | 95 | C |
| Example 2 | 0 | 0 | 0.023 | 0.82 | 104 | B |
| Example 3 | 0 | 0 | 0.034 | 0.81 | 114 | A |
| Example 4 | 0 | 0 | 0.047 | 0.84 | 111 | A |
| Example 5 | 0 | 0 | 0.062 | 0.88 | 107 | B |
| Example 6 | 0 | 0 | 0.073 | 0.84 | 97 | C |
| Example 7 | 0 | 0 | 0.096 | 0.83 | 91 | C |
| Example 8 | 0.8 | 0 | 0.037 | 2.46 | 104 | A |
| Example 9 | 0.6 | 0 | 0.035 | 2.41 | 106 | A |
| Example 10 | 0.4 | 0 | 0.033 | 2.45 | 107 | A |
| Example 11 | 0.2 | 0 | 0.035 | 2.43 | 109 | A |
| Example 12 | 0.7 | 0.05 | 0.055 | 2.67 | 87 | A |
| Example 13 | 0.7 | 0.05 | 0.053 | 2.64 | 104 | A |
| Example 14 | 0.7 | 0.05 | 0.051 | 2.61 | 88 | A |
| Example 15 | 0.7 | 0.05 | 0.056 | 2.63 | 100 | A |
| Example 16 | 0 | 0.00 | 0.038 | 0.53 | 106 | B |
| Example 17 | 0 | 0.00 | 0.041 | 0.46 | 98 | C |
| Example 18 | 0 | 0.00 | 0.044 | 0.35 | 92 | C |
| Example 19 | 0.7 | 0.05 | 0.052 | 3.36 | 80 | C |
| Example 20 | 0.7 | 0.05 | 0.053 | 3.04 | 83 | C |
| Example 21 | 0.7 | 0.05 | 0.054 | 2.91 | 89 | B |

TABLE 2

| | | Spectrum 1 | | | Spectrum 2 | | |
|---|---|---|---|---|---|---|---|
| | | Isomer | Quadrupolar | Area | Isomer | Quadrupolar | Area |
| | | shift | split | intensity | shift | split | intensity |
| | Chemical formula | [mm/s] | [mm/s] | α | [mm/s] | [mm/s] | β |
| Comparative | LiFeP0₄ | 1.23 | 2.96 | 1.000 | — | — | 0.000 |
| Example 1 | | | | | | | |
| Comparative | LiFeP0₄ | 1.22 | 2.97 | 0.992 | 0.54 | 0.53 | 0.008 |
| Example 2 | | | | | | | |
| Comparative | LiFeP0₄ | 1.23 | 2.97 | 0.892 | 0.54 | 0.55 | 0.108 |
| Example 3 | | | | | | | |
| Comparative | LiFe_{0.2}Mn_{0.8}P0₄ | 1.26 | 2.96 | 1.000 | — | — | 0.000 |
| Example 4 | | | | | | | |
| Comparative | LiFe_{0.4}Mn_{0.6}P0₄ | 1.24 | 2.97 | 1.000 | — | — | 0.000 |
| Example 5 | | | | | | | |
| Comparative | LiFe_{0.6}Mn_{0.4}P0₄ | 1.25 | 2.96 | 1.000 | — | — | 0.000 |
| Example 6 | | | | | | | |
| Comparative | LiFe_{0.8}Mn_{0.2}P0₄ | 1.23 | 2.97 | 1.000 | — | — | 0.000 |
| Example 7 | | | | | | | |
| Comparative | LiFe_{0.25}Mn_{0.7}Zn_{0.05}P0₄ | 1.25 | 2.96 | 1.000 | — | — | 0.000 |
| Example 8 | | | | | | | |
| Comparative | LiFe_{0.25}Mn_{0.7}Mg_{0.05}P0₄ | 1.25 | 2.96 | 1.000 | — | — | 0.000 |
| Example 9 | | | | | | | |
| Comparative | LiFe_{0.25}Mn_{0.7}Ni_{0.05}P0₄ | 1.26 | 2.96 | 1.000 | — | — | 0.000 |
| Example 10 | | | | | | | |
| Comparative | LiFe_{0.25}Mn_{0.7}Co_{0.05}P0₄ | 1.25 | 2.97 | 1.000 | — | — | 0.000 |
| Example 11 | | | | | | | |
| Comparative | LiFeP0₄ | 1.23 | 2.96 | 0.951 | 0.55 | 0.55 | 0.049 |
| Example 12 | | | | | | | |
| Comparative | LiFe_{0.25}Mn_{0.7}Co_{0.05}P0₄ | 1.25 | 2.97 | 0.798 | 0.44 | 0.74 | 0.202 |
| Example 13 | | | | | | | |
| Comparative | LiFeP0₄ | 1.22 | 2.96 | 1.000 | — | — | 0.000 |
| Example 14 | | | | | | | |

| | | | | Content | 10 C | |
|---|---|---|---|---|---|---|
| | | | | of carbon | discharge | |
| | | | β/(β + α) × | element | capacity | Battery |
| | y | z | (1 − y − Z) | [% by weight] | {mAh/g} | evaluation |
| Comparative | 0 | 0 | 0.000 | 0.91 | 89 | D |
| Example 1 | | | | | | |
| Comparative | 0 | 0 | 0.008 | 0.87 | 88 | D |
| Example 2 | | | | | | |
| Comparative | 0 | 0 | 0.108 | 0.79 | 87 | D |
| Example 3 | | | | | | |
| Comparative | 0.8 | 0 | 0.000 | 2.51 | 76 | D |
| Example 4 | | | | | | |
| Comparative | 0.6 | 0 | 0.000 | 2.55 | 81 | D |
| Example 5 | | | | | | |
| Comparative | 0.4 | 0 | 0.000 | 2.56 | 85 | D |
| Example 6 | | | | | | |
| Comparative | 0.2 | 0 | 0.000 | 2.71 | 88 | D |
| Example 7 | | | | | | |
| Comparative | 0.7 | 0.05 | 0.000 | 2.73 | 42 | D |
| Example 8 | | | | | | |
| Comparative | 0.7 | 0.05 | 0.000 | 2.71 | 81 | D |
| Example 9 | | | | | | |
| Comparative | 0.7 | 0.05 | 0.000 | 2.75 | 54 | D |
| Example 10 | | | | | | |
| Comparative | 0.7 | 0.05 | 0.000 | 2.72 | 78 | D |
| Example 11 | | | | | | |
| Comparative | 0 | 0.00 | 0.049 | 0.27 | 79 | D |
| Example 12 | | | | | | |
| Comparative | 0.7 | 0.05 | 0.051 | 3.45 | 76 | D |
| Example 13 | | | | | | |
| Comparative | 0 | 0.00 | 0.000 | 0.29 | 63 | D |
| Example 14 | | | | | | |

When Example 1 to Example 7 and Comparative Example 1 are compared with each other, it was confirmed that, in Example 1 to Example 7 in which {(β/(β+α)×(1−y−z)} was 0.01 or more and 0.1 or less, the 10 C discharge capacity improved compared with Comparative Example 1 in which the trivalent Fe source was not added. On the other hand, it was confirmed that, in Comparative Example 2 and Comparative Example 3 in which {β/(β+α)×(1−y−z)} was not 0.01 or more and 0.1 or less, the 10 C discharge capacity decreased compared with Comparative Example 1 in which the trivalent Fe source was not added.

When Example 8 to Example 15 and Comparative Example 4 to Comparative Example 11 are compared with each other, it was confirmed that, in Example 8 to Example 15 in which {β/(β+α)×(1−y−z)} was 0.01 or more and 0.1 or less, the 10 C discharge capacity improved compared with Comparative Example 4 to Comparative Example 11 in which the trivalent Fe source was not added.

When Example 1 to Example 21 and Comparative Example 1, Comparative Example 4 to Comparative Example 11 are compared with each other, it was confirmed that, in Example 1 to Example 21 in which the content of the carbon atom was 0.3% by mass or more and 3.4% by mass or less, the 10 C discharge capacity improved compared with Comparative Example 1 and Comparative Example 4 to Comparative Example 11 in which the trivalent Fe source was not added. On the other hand, when Comparative Example 12 to Comparative Example 14, Comparative Example 1, and Comparative Example 11 are compared with each other, it was confirmed that, in Comparative Example 12 to Comparative Example 14 in which the content of the carbon atom was 0.3% by mass or more and 3.4% by mass or less, the 10 C discharge capacity improved compared with Comparative Example 1 and Comparative Example 11 in which the trivalent Fe source was not added.

The cathode material for a lithium ion secondary battery of the present invention is a cathode material for a lithium ion secondary battery formed by coating the surface of a central particle represented by General Formula LixFe1−y−zAyMzPO4 (here, Δ represents at least one selected from the group consisting of Mn, Co, and Ni, M represents at least one selected from the group consisting of Mg, Ca, Co, Sr, Ba, Ti, Zn, B, Al, Ga, In, Si, Ge, and rare earth elements, 0.85≤x≤1.1, 0≤y≤0.85, and 0≤z≤0.2) with a carbonaceous film, in which the content of a carbon atom is 0.3% by mass or more and 3.4% by mass or less, and, in a Moessbauer spectrum obtained by Moessbauer spectroscopy, when the area intensity of a spectrum having an isomer shift value in a range of 1.0 mm/sec or more and 1.4 mm/sec or less is represented by α, and the area intensity of a spectrum having an isomer shift value in a range of 0.3 mm/sec or more and 0.7 mm/sec or less is represented by β, {β/(β+α)×(1−y−z)} is 0.01 or more and 0.1 or less, and thus the discharge capacity of a lithium ion secondary battery provided with a cathode for a lithium ion secondary battery produced using this cathode material for a lithium ion secondary battery increases, and thus the lithium ion secondary battery can be applied to next-generation secondary batteries from which a high voltage, a higher energy density, higher load characteristics, and higher-rate charge and discharge characteristics are anticipated, and, in the case of a next-generation secondary battery, an effect thereof is extremely significant.

1. A cathode material for a lithium ion secondary battery formed by coating a surface of a central particle represented by General Formula LixFe1−y−zAyMzPO4 (here, Δ represents at least one selected from the group consisting of Mn, Co, and Ni, M represents at least one selected from the group consisting of Mg, Ca, Co, Sr, Ba, Ti, Zn, B, Al, Ga, In, Si, Ge, and rare earth elements, 0.85≤x≤1.1, 0≤y≤0.85, and 0≤z≤0.2) with a carbonaceous film,
wherein a content of a carbon atom is 0.3% by mass or more and 3.4% by mass or less, and,
in a Moessbauer spectrum obtained by Moessbauer spectroscopy, when an area intensity of a spectrum having an isomer shift value in a range of 1.0 mm/sec or more and 1.4 mm/sec or less is represented by α, and an area intensity of a spectrum having an isomer shift value in a range of 0.3 mm/sec or more and 0.7 mm/sec or less is represented by β, {β/(β+α)×(1−y−z)} is 0.01 or more and 0.1 or less.

2. The cathode material for a lithium ion secondary battery according to claim 1,
wherein, in the Moessbauer spectrum obtained by the Moessbauer spectroscopy, the spectrum having the isomer shift value in a range of 1.0 mm/sec or more and 1.4 mm/sec or less and the spectrum having the isomer shift value in a range of 0.3 mm/sec or more and 0.7 mm/sec or less are split into two parts respectively.

3. The cathode material for a lithium ion secondary battery according to claim 1,
wherein, in the Moessbauer spectrum obtained by the Moessbauer spectroscopy, a quadrupolar splitting value of the spectrum having an isomer shift value in a range of 0.3 mm/sec or more and 0.7 mm/sec or less is 0.4 mm/sec or more and 1.1 mm/sec or less.

4. The cathode material for a lithium ion secondary battery according to claim 1,
wherein, in the Moessbauer spectrum obtained by the Moessbauer spectroscopy, six magnetically split peaks are not included.

5. The cathode material for a lithium ion secondary battery according to claim 1,
wherein the {(β/(β+α)×(1−y−z)} is 0.02 or more and 0.07 or less.

6. The cathode material for a lithium ion secondary battery according to claim 1,
wherein the central particle is made of LiFePO₄.

7. A cathode for a lithium ion secondary battery, comprising:
an electrode current collector; and
a cathode mixture layer formed on the electrode current collector,
wherein the cathode mixture layer contains the cathode material for a lithium ion secondary battery according to claim 1.

8. A lithium ion secondary battery comprising:
a cathode;
an anode; and
a non-aqueous electrolyte,
wherein the cathode for a lithium ion secondary battery according to claim 7 is provided as the cathode.
